(19) United States
(12) Patent Application Publication
(10) Pub. No.: US 2015/0366744 A1
(43) Pub. Date: Dec. 24, 2015

(54) Scalp Scratching Assembly

(71) Applicant: Wakesha Rivers, Buena Park, CA (US)

(72) Inventor: Wakesha Rivers, Buena Park, CA (US)

(21) Appl. No.: 14/310,592

(22) Filed: Jun. 20, 2014

(51) Int. Cl. A61H 7/00

(52) U.S. Cl. CPC A61H 7/00

(57) ABSTRACT

A scalp scratching assembly for penetrating a hair accoutrement without disturbing the hair accoutrement includes a shaft that has an adjustable length. At least one pad is coupled to an end of the shaft. The at least one pad is textured. The at least one pad may abrade a user's scalp. The at least one pad is insertable through the hair accoutrement. The hair accoutrement remains stationary while the shaft is moved. The at least one pad scratches the user's scalp.

### BACKGROUND OF THE DISCLOSURE

### Field of the Disclosure

The disclosure relates to scratching devices and more particularly pertains to a new scratching device for penetrating a hair accoutrement without disturbing the hair accoutrement.

### SUMMARY OF THE DISCLOSURE

An embodiment of the disclosure meets the needs presented above by generally comprising a shaft that has an adjustable length. At least one pad is coupled to an end of the shaft. The at least one pad is textured. The at least one pad may abrade a user's scalp. The at least one pad is insertable through a hair accoutrement. The hair accoutrement remains stationary while the shaft is moved. The at least one pad scratches the user's scalp.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a scalp scratching assembly according to an embodiment of the disclosure.

FIG. 2 is an in-use view of an embodiment of the disclosure.

FIG. 3 is a right side view of an embodiment of the disclosure.

FIG. 4 is a left side view of an embodiment of the disclosure.

FIG. 5 is a top perspective view of an embodiment of the disclosure.

FIG. 6 is a schematic view of a method of utilizing an embodiment of the disclosure.

### DESCRIPTION OF THE PREFERRED EMBODIMENT

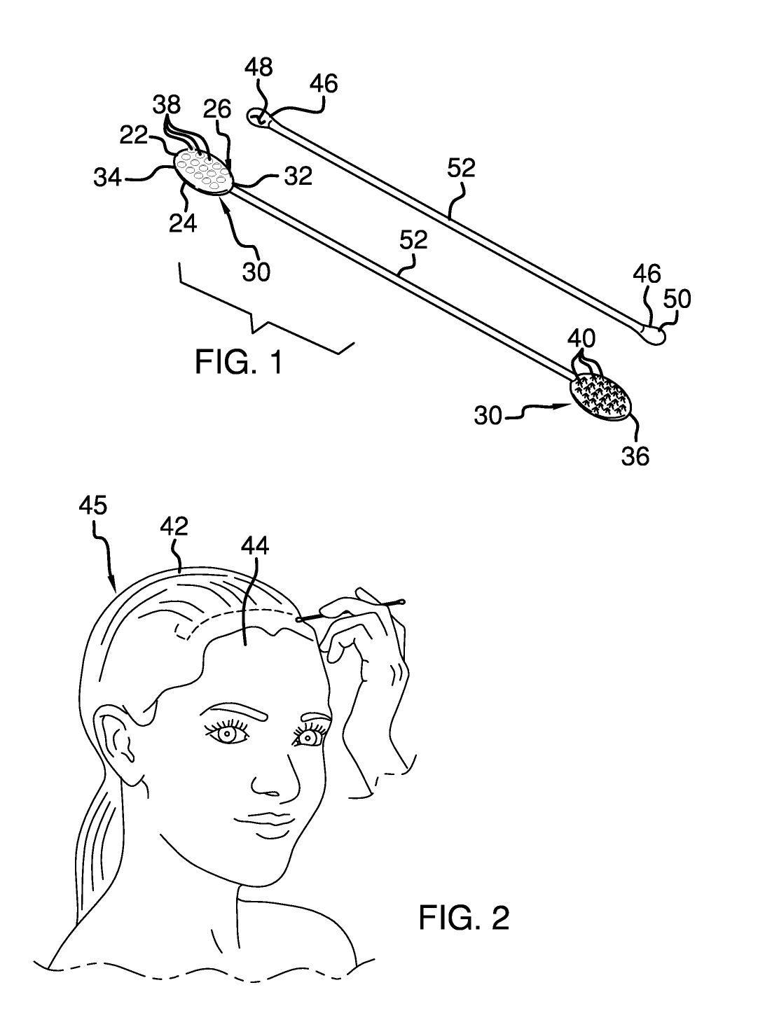

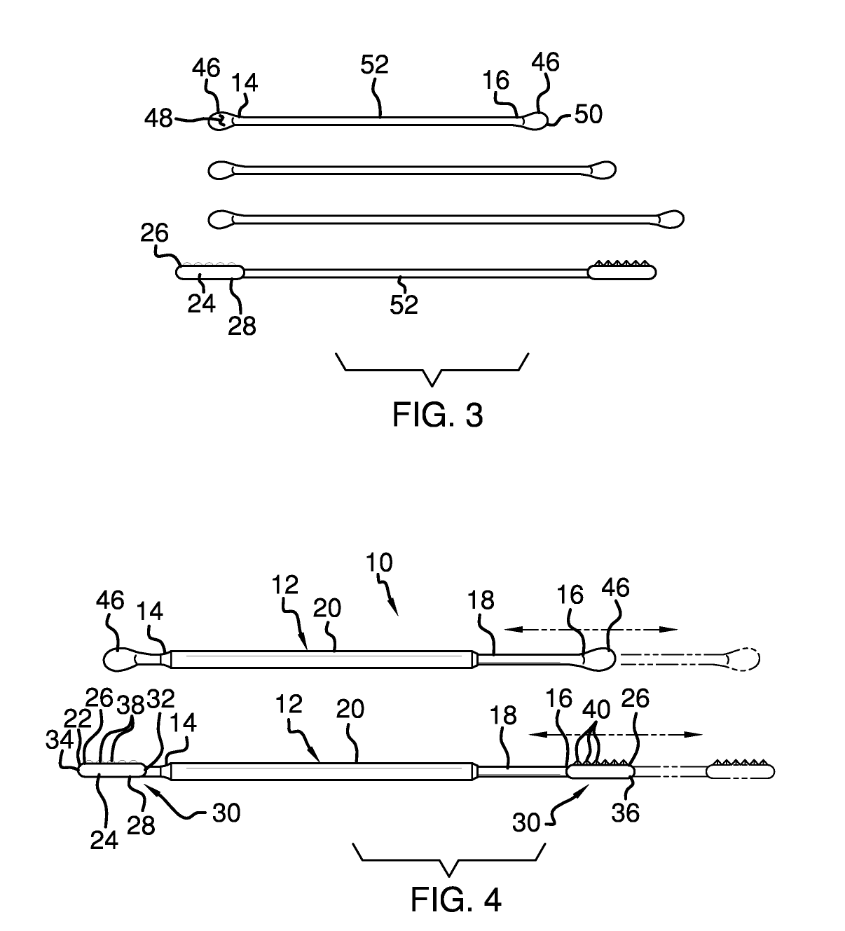

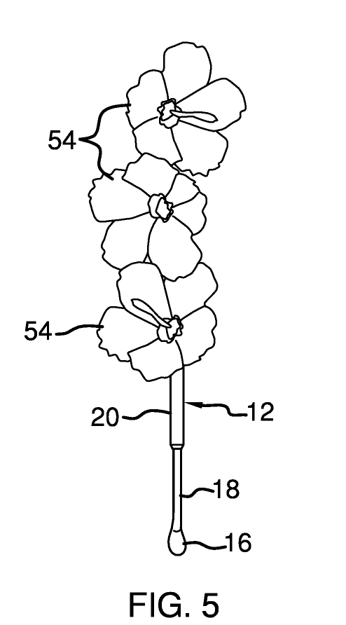

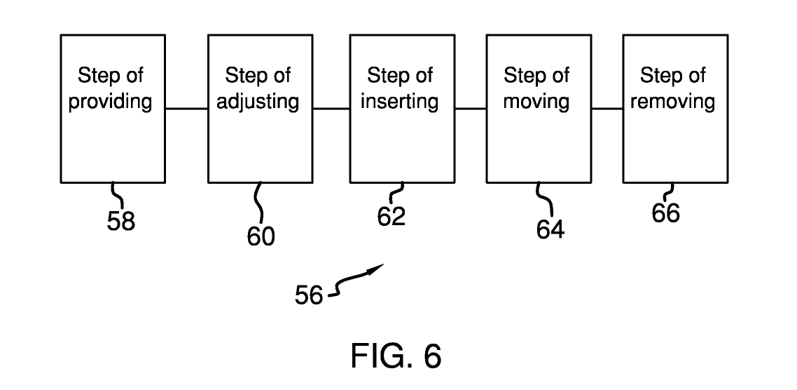

With reference now to the drawings, and in particular to FIGS. 1 through 6 thereof, a new scratching device embodying the principles and concepts of an embodiment of the disclosure and generally designated by the reference numeral 10 will be described.

As best illustrated in FIGS. 1 through 6, the scalp scratching assembly 10 generally comprises a shaft 12. The shaft 12 has a first end 14 and a second end 16. The shaft 12 is elongated between the first 14 and second 16 ends of the shaft 16. The shaft 12 has a first section 18 of said shaft that is slidably coupled to a second section 20 of the shaft 12. Moreover, the shaft 12 has a telescopically adjustable length.

At least one pad 22 is provided. The at least one pad 22 has an exterior edge 24 extending between each of a top surface 26 and a bottom surface 28 of the at least one pad 22. Moreover, the exterior edge 24 of the at least one pad 22 is curved. The at least one pad 22 has an ovoid shape.

The top surface 26 of the at least one pad 22 is textured. Additionally, the at least one pad 22 may be comprised of a resiliently compressible material. The at least one pad 22 is one of a pair of the pads 30. A narrow side 32 of the exterior edge 24 of each of the pair of pads 30 is coupled to an associated one of the first 14 and second 16 ends of the shaft 12.

The top surface 26 of a first one of the pair of pads 34 has a unique texture with respect to a second one of the pair of pads 36. The top surface 26 of the first pad 34 may comprise a plurality of hemispherical prominences 38. The plurality of hemispherical prominences 38 extends upwardly from the top surface 26 of the first pad 34. Additionally, the plurality of hemispherical prominences 38 are evenly spaced apart and distributed over the entirety of the top surface 26 of the first pad 34.

The top surface 26 of the second pad 36 may comprise a plurality of conical prominences 40. The plurality of conical prominences 40 extends upwardly from the top surface 26 of the second pad 36. Moreover, the plurality of conical prominences 40 are evenly spaced apart and distributed over the entirety of the top surface 26 of the second pad 36.

A selected one of the pair of pads 36 is insertable through a hair accoutrement 42 so the top surface 26 of the selected pair of pads 36 engages the user's scalp 44. The hair accoutrement 42 remains stationary while the shaft 12 is moved. The selected one of the pair of pads 36 scratches the user's scalp 44. The hair accoutrement 42 may be a hair weave of any conventional design that is worn on the user's head 45.

In an alternative embodiment, a pair of lobes 46 may each be coupled to an associated one of the first 14 and second 16 ends of the shaft 12. An outer surface 48 of each of the pair of lobes 46 is curvilinear. Each of the pair of lobes 46 has a tear drop shape. A selected one of the pair of lobes 46 is insertable through the hair accoutrement 42 so a wide end 50 of the selected one of the pair of lobes 46 engages the user's scalp 44. Continuing in the alternative embodiment, the shaft 12 may be a non telescopically adjustable shaft 52. The non telescopically adjustable shaft 52 may come in a plurality of lengths.

A plurality of decorative elements 54 may be coupled to the second section 20 of the shaft 12. The plurality of decorative elements 54 may be evenly spaced apart and distributed along an entire length of the second section 20 of the shaft 12. Each of the plurality of decorative elements 54 may have a floral shape.

In use, a method 56 of scratching the user's scalp 44 while the user wears the hair accoutrement 42 such that the hair accoutrement 42 remains stationary comprises the step 58 of providing the shaft 12 that has the first section 18 of the shaft 12 slidably coupled to the second section 20 of the shaft 12. The shaft 12 additionally has the first 14 and second 16 ends, and the pair of pads 36 each coupled to an associated one of the first 14 and second 16 ends of the shaft 12. Continuing, the method 56 includes the step 60 of adjusting a length of the shaft 12. The method 56 additionally includes the step 62 of inserting a selected one of the pair of pads 36 through the hair accoutrement 42 so the selected one of the pair of pads 36 engages the user's scalp 44. The hair accoutrement 42 remains stationary. Further, the method 56 includes the step 64 of moving the shaft 12 so the selected one of the pair of pads 36 abrades the user's scalp 44. The method 56 finally includes the step 66 of removing the selected one of the pair of pads 36 from the hair accoutrement 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A scalp scratching assembly to penetrate a hair accoutrement without disturbing the hair accoutrement, said assembly comprising:
a shaft having an adjustable length;
at least one pad coupled to an end of said shaft, said at least one pad being textured wherein said at least one pad is configured to abrade a user's scalp; and
said at least one pad being insertable through the hair accoutrement wherein the hair accoutrement remains stationary while said shaft is moved such that said at least one pad scratches the user's scalp.

2. The assembly according to claim 1, wherein said shaft having a first end and a second end.

3. The assembly according to claim 1, wherein said shaft having a first section of said shaft slidably coupled to a second section of said shaft such that said shaft has a telescopically adjustable length.

4. The assembly according to claim 1, wherein said at least one pad having an exterior edge extending between a top surface and a bottom surface of said at least one pad.

5. The assembly according to claim 1, wherein an exterior edge of said at least one pad being curved such that said at least one pad has an ovoid shape.

6. The assembly according to claim 1, wherein a top surface of said at least one pad being textured.

7. The assembly according to claim 1, wherein said at least one pad being one of a pair of said pads.

8. The assembly according to claim 7, wherein a narrow side of an exterior edge of each of said pair of pads being coupled to an associated one of a first end and a second end of said shaft.

9. The assembly according to claim 7, wherein a selected one of said pair of pads being insertable through the hair accoutrement such that a top surface of said selected pair of pads engages the user's scalp.

10. The assembly according to claim 7, wherein a top surface of a first one of said pair of pads having a unique texture with respect to a second one of said pair of pads.

11. A scalp scratching assembly to penetrate a hair accoutrement without disturbing the hair accoutrement, said assembly comprising:
a shaft having a first end and a second end, said shaft having a first section of said shaft slidably coupled to a second section of said shaft such that said shaft has a telescopically adjustable length;
at least one pad having an exterior edge extending between a top surface and a bottom surface of said at least one pad, said exterior edge of said at least one pad being curved such that said at least one pad has an ovoid shape, said top surface of said at least one pad being textured;
said at least one pad being one of a pair of said pads;
a narrow side of said exterior edge of each of said pair of pads being coupled to an associated one of said first and second ends of said shaft;
said top surface of a first one of said pair of pads having a unique texture with respect to a second one of said pair of pads; and
a selected one of said pair of pads being insertable through the hair accoutrement such that said top surface of said selected pair of pads engages the user's scalp, the hair accoutrement remaining stationary while said shaft is moved such that said selected one of said pair of pads scratches the user's scalp.

12. A method of scratching a user's scalp while the user wears a hair accoutrement such that the hair accoutrement remains stationary, the steps of the method comprising:
providing said shaft having said first section of said shaft slidably coupled to said second section of said shaft, said shaft having said first and second ends, and said pair of pads each coupled to an associated one of said pair of first and second ends of said shaft;
adjusting a length of said shaft;
inserting a selected one of said pair of pads through the hair accoutrement having said selected one of said pair of pads engages the user's scalp such that the hair accoutrement remains stationary;
moving said shaft such that said selected one of said pair of pads abrades the user's scalp; and
removing said selected one of said pair of pads from the hair accoutrement.
